(19) United States
(12) Patent Application Publication
(10) Pub. No.: US 2005/0281320 A1
(43) Pub. Date: Dec. 22, 2005

(54) Low power wireless communication system and protocol

(75) Inventor: Charles F. Neugebauer, Los Altos, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(73) Assignee: W5 Network

(21) Appl. No.: 11/155,125

(22) Filed: Jun. 16, 2005

Related U.S. Application Data
(60) Provisional application No. 60/580,678, filed on Jun. 17, 2004.
(60) Provisional application No. 60/582,888, filed on Jun. 25, 2004.
(60) Provisional application No. 60/605,568, filed on Aug. 30, 2004.

(51) Int. Cl. H04B 1/707

(52) U.S. Cl. 375/141

(57) ABSTRACT

A wireless communication system and protocol are disclosed. The system includes at least one tag and at least one access point. The access point transmits a beacon signal that includes a predetermined binary sequence such as a pseudonoise (PN) sequence. The tag typically does not include an expensive accurate frequency generator component, such as a crystal oscillator. The tag searches for the beacon signal using a fast Walsh transform. Specifically, the tag performs fast Walsh transforms on received data to locate the beacon signal. Once the beacon signal is located, an accurate frequency reference signal can be established at the tag, allowing the tag and access point to transfer information to one another via a wireless, spread spectrum communication link.

### CROSS-REFERENCE TO RELATED APPLICATIONS

This application claims priority to U.S. Provisional Application Ser. Nos. 60/580,678, filed on Jun. 17, 2004, 60/582,888, filed on Jun. 25, 2004, and 60/605,568, filed on Aug. 30, 2004. Priority to these prior applications is expressly claimed, and the disclosures are hereby incorporated by reference in their entireties.

This application is related to U.S. patent application Ser. No. ______, filed on Jun. 16, 2005 entitled “Pseudo Noise Coded Communication Systems” and having Attorney Docket Number 16051-4002. The disclosure of this application is hereby incorporated by reference in its entirety.

### FIELD

The present disclosure relates to low power wireless communication systems.

### BACKGROUND

Wireless communication systems typically include multiple fixed transceiver devices that communicate with multiple remote transceiver devices. Generally, the number of remote transceiver devices in such systems is greater than the number of fixed transceiver devices.

As is well known, the remote and fixed devices need to generate the same accurate frequency reference signal to effectively communicate with one another. If the frequency generators deviate sufficiently from one another, the devices cannot communicate with one another. Unfortunately, many applications for wireless communications systems today require the use of a large number of low cost, low power remote devices. However, it is difficult produce low cost remote devices because they require a relatively expensive component or circuit, such as a crystal oscillator, to generate an accurate frequency reference signal.

In view of the foregoing and other disadvantages, a need exists for an improved low power wireless communication system and protocol.

### SUMMARY

An improved low power wireless communication system and protocol are disclosed. The communication system includes one or more tags that communicate with one or more access points via a wireless communication link. The access point(s) transmit a beacon signal that is received by the tag(s). The tag(s) search for the beacon signal using a fast Walsh transform. The beacon signal allows the tag(s) to establish an accurate frequency reference signal that is synchronized to the frequency reference signal that is generated in the access points.

Other aspects and features will become apparent from consideration of the following description taken in conjunction with the accompanying drawings.

### BRIEF DESCRIPTION OF THE DRAWINGS

FIG. 1 is a block diagram of an exemplary communications network.

FIG. 2 is a block diagram of an exemplary tag.

FIG. 3 is a flow diagram of an exemplary communication session between an access point and a tag.

FIG. 4 is an exemplary state flow diagram for a tag.

FIG. 5 is an exemplary state flow diagram for performing a beacon search.

FIG. 6 is an exemplary state flow diagram for performing a code phase search.

FIG. 7 is a detailed block diagram of an exemplary tag.

FIG. 8 shows an exemplary operation diagram for the fast Walsh transform (FWT) performed in the tag of FIG. 7.

FIG. 9 is a block diagram of an exemplary access point.

FIG. 10 is a timing diagram that shows the times during a chip period when the tag's oscillator needs to run.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not describe every aspect of the present invention and do not limit the scope of the invention.

### DETAILED DESCRIPTION

Turning to the figures, exemplary embodiments will now be described.

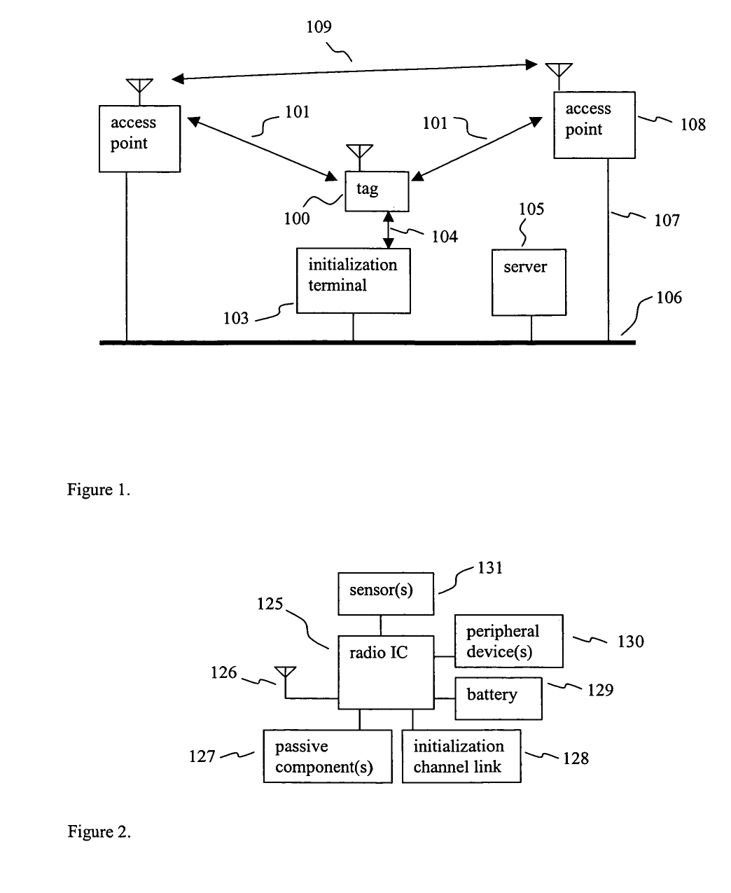

FIG. 1 is a block diagram of an exemplary communications system. The communication system includes a tag 100, wireless access points 108, an initialization terminal 103, a server 105, and a data network 106. Wireless access points 108 communicate with tag 100 via wireless communication links 101 and with one another via wireless communication link 109. Wireless access points 108 communicate with data network 106 via communication links 107, which may be wired or wireless communication links. Data network 106 can be any type of data network, such as a local area network (LAN). Server 105 and initialization terminal 103 communicate with one another via communication links 110 and 111, respectively, both of which may be wired or wireless communication links. The communication links described herein may be encoded using known encryption algorithms in order to increase the security of data transmitted over the link.

Although FIG. 1 depicts a single tag 100, two access points 108, a single initialization terminal 103 and a single server 105, it should be recognized that the communication network can include any number of tags 100, access points 108, initialization terminals 103 and servers 105. For example, a communications network may include hundreds or thousands of tags 100 each of which is capable of communication with at least one access point 102.

Access points 108 can directly communicate with each other via wireless communication links 109, for example, to synchronize and calibrate a positioning function. Access points 108 are connected to the network 106 via a wired or wireless communications link 107. Thus, access points 108, server 105 and initialization terminal 103 can communicate with each other via the network 106.

Tag 100 is a device that is capable of transmitting information, commands, data, and/or signals via wireless communication link 101 and/or capable of receiving information, commands, data and/or signals via wireless communication link 101. Tag 100 can be initialized by server 105 using initialization terminal 103 via a communication link 104. Tag 100 can be initilized with a wide variety of information depending on its application, such as a unique ID code, and expected beacon code, a site ID code, encryption keys, initial price/display information, etc.

In one embodiment, tag 100 aggregates outgoing (transmitted) data in a local data storage or memory (not shown). The data may then be transmitted in bursts in order to improve the quality of the communication link, capacity of the wireless channel and/or the power efficiency of the system. In addition, the transmission power of tag 100 can be modulated or adjusted using commands or instructions generated by access points 108 and/or server 105 in order to reduce interference, save power and/or increase network capacity. Additionally, the transmission power, frequency, timing, coding and/or waveshape of the radio frequency (RF) signal produced by tag 100 can be modulated or adjusted by tag 100 in response to sensed parameters such as battery status, local interference from metal and/or liquids, temperature, etc.

In another embodiment, tag 100 can send or transmit a pre-assigned ID code key, optional status data concerning the state of tag 100, such as from a tamper sensor or a detected battery level, and/or radio transmit or receive parameters, such as signal strength. This information may be transmitted via wireless channel 101 to one or more access points 108 either alone or in combination with other information, signals, data, commands, etc.

In another embodiment, tag 100 receives information from one or more access points 108 via wireless channel 101 and/or from the initialization terminal 103 via communication link 104. This information may include, e.g., one or more of target transmit power level, indicator commands, status queries, security keys, initial state information, diagnostic commands and/or identification code information.

Any suitable communication protocol can be utilized for wireless communication link 109. Wireless communication link 109 may be based on a known communication standard, such as IEEE 802.11 and 802.15 families of standards, including but not limited to 802.11a, 802.11b, 802.11g, 802.15.1, 802.15.3, 802.15.3a, and 802.15.4, which standard protocols are incorporated herein by reference. In addition or in the alternative, wireless communication link 109 may be based upon a low data rate multiple access impulse radio protocol.

Any suitable communication protocol can also be utilized for communication link 104. Communication link 104 may be based on a known communication standard, such as I2C, USB, RS-232, IrDA and SPI, which standard protocols are incorporated herein by reference. The initialization link may also employ direct electrical contact, capacitive coupling, magnetic coupling or optical coupling as a means of communicating.

Access points 108, initialization terminal 103 and server 105 can communicate using any suitable communication protocol, such as standard Transmission Control Protocol/Internet Protocol (TCP/IP) via a wired LAN or one or more wireless LANs. Representative examples of wireless LANs that may be utilized include the standards IEEE 802.11a, 802.11b, 802.11g and their derivatives or extensions, all of which are incorporated herein by reference.

Server 105 includes a processor that communicates with memory. The term “server” is intended to encompass any computing device(s) that is capable of controlling and monitoring the network 106, receiving signals from the access points 108 and/or transmitting signals to one or more tags 100 via the access points 108. The memory may store one or more control programs for operating and/or administering the server 105 and the network 106, including all components within network 106. In addition, the memory may store various information concerning the operation of a facility (e.g., a warehouse or factory), including but not limited to pricing information, orders, inventory, shipping and receiving records, asset information, security information, personnel information, component information, version information, etc. This information can be accessed for use with the various tags 100 disclosed herein. Two or more servers 105 may be utilized in combination, as system requirements will determine the specific design and functions that are appropriate for servers. For example, a first memory may store the control program(s) and a second memory may store other useful information and data, such as the inventory records. In this case, server 105 can access this information, even if such information is stored on a different server 105.

The control programs running on server 105 typically generate, assign, store, compare, communicate and/or validate the ID code keys and data streams of tags 100 and access points 108. Furthermore, the control programs running on server 105 can validate or check interactions between tags 100. Server 105 can transmit validation signals back to tags 100 indicating the status of such validation and instructions.

FIG. 2 is a block diagram of an exemplary tag 100. Tag 100 includes one or more of the following components: a radio integrated circuit (IC) 125, an antenna 126, one or more optional passive components 127, an initialization channel link 128, a battery or other power source 129, one or more optional peripheral devices 130 and one or more optional sensors 131. Representative passive components 127 include, for example, capacitors or resistors. Representative peripheral devices 130 include, for example, a two-way audio processor capable of receiving and transmitting audio information or a liquid crystal display (LCD) and its associated controller. Representative sensors 131 include, for example, a button, a tamper detector, a temperature sensor or a battery status sensor.

The term “battery” is intended to encompass any type of portable electrical power source, control or storage means, such as button cells (e.g., watch batteries), lithium batteries, silver chloride batteries, zinc chloride batteries, carbon zinc batteries, nickel cadmium batteries, nickel metal hydride batteries, lithium-ion batteries, polymer-based batteries, alkaline batteries, fuel cells, capacitors, solar cells, vibration converters, thermal power generators or laminated chemical batteries. In a preferred embodiment, the battery may comprise a small disposable battery based on zinc and manganese dioxide, which battery optionally may be attached to a substrate and encapsulated in plastic.

The term “sensor” or “sensors” is intended to encompass any type of electrical switches, capacitive touch sensors, optically activated inputs, temperature sensors, voltage sensors or any other input mechanism or sensor. In other words, the term “sensor” is intended to encompass a wide variety of known data input devices.

The term “controller” is intended to encompass processors, such as microprocessors, electronic control devices, state machines and other circuits that may be utilized to electronically control the operation of other circuit elements. In addition, the present controllers may be connected to, or may incorporate therein, memory or storage for storing one or more control programs that are executed by the controller.

Elements of antenna 126 can serve as part of a tamper or capacitive sensor input using capacitive and/or resistive coupling. In one embodiment, a dipole antenna may include two large area capacitive or resistive plates that are capable of functioning as sensors. Tag 100 communicates with access points 108 via a low data rate protocol described below through antenna 126.

Additional components such as sensors 131 and/or peripherals 130 may be added to the circuit depending on the application. Similarly, components may be removed depending on the application. For example, battery 129 may be removed if tag 100 is used in a system with an external power source, such as a compact wireless add-in card for a cell phone, camera or personal digital assistant (PDA).

Many applications can make use of a low data rate, low power, low cost wireless communication systems, including but not limited to electronic shelf labels, pharmaceutical tracking, supply chain management, point of sale terminal communication, asset management, sensor networks, building control systems, voice networks, computer networks and security networks. In a voice network application, tag 100 can be embedded within a wireless headset (not shown) comprised of tag 100 and an audio processor peripheral 130 which receives, processes and transmits audio information to/from an earphone and microphone, respectively. In an electronic shelf label application, tag 100 can be embedded within an electronic shelf label comprised of a tag 100 and an LCD or other display peripheral 130 for indicating prices in a retail environment, such as a grocery store. In this example, tag 100 receives updated pricing from a central server 105 via access points 108 and displays the price on the LCD peripheral 130.

In operation, tag 100 transmits one or more signals that are received by one or more wireless access points 108. Based upon the relative time of arrival of the transmitted signal to reference signals (from, e.g., reference tags) or to a global time reference maintained at each access point 108, the relative signal strength, and/or the multipath signature information received at one or more wireless access points 108 via wireless communication link 101 (FIG. 1), the location of the tag can be derived or determined by server 105. Various techniques, algorithms and programs for “triangulating” or determining the position or location of a tracked tag 100 using signal information received from tag 100 by three or more non-coplanar wireless access points 108 are well known in the art. Likewise, various techniques, algorithms and programs for determining the position of a tag 100 using two access points 108 are also well known in the art.

In one embodiment, communication link 101, which is the communication link between access point 108 and tag 100, comprises two sub-links. The first sub-link is used for access point-to-tag communications. This link is the ISM band centered at 2.44 GHz with a channel bandwidth of 60 MHz. The second sub-link is used for tag-to-access point communications. This link is in the ultra wide band (UWB) centered at 4.1 GHz. It should be recognized that any suitable frequencies and bands can be used for communications between tags 100 and access points 108.

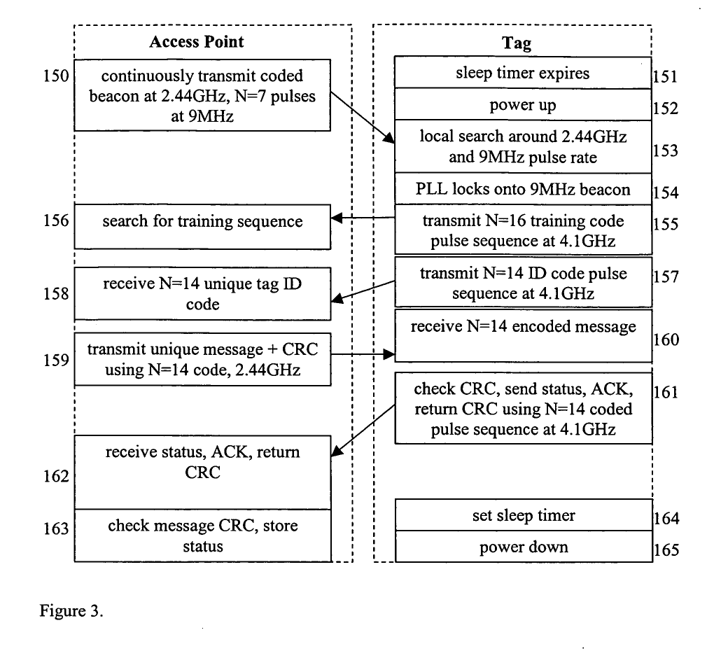

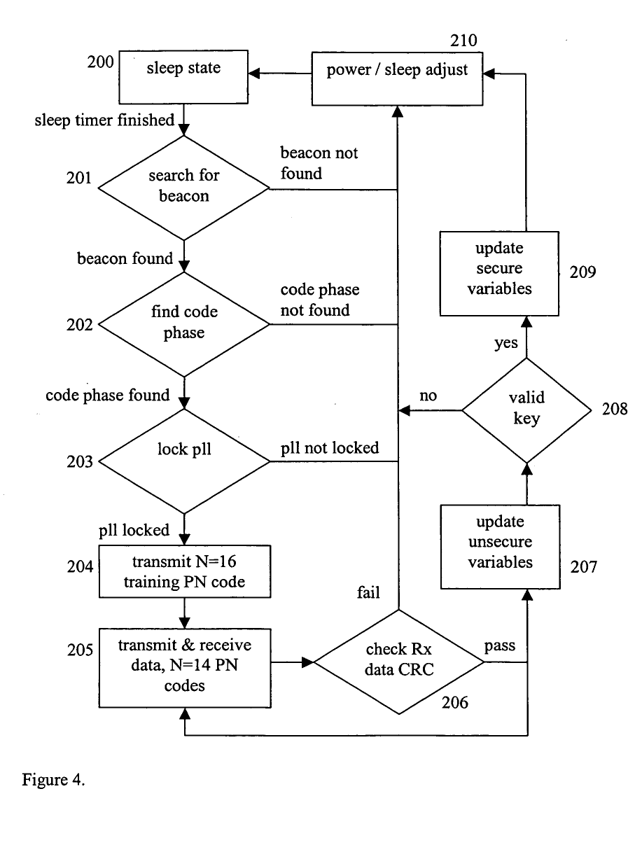

FIG. 3 is a flow diagram of an exemplary communication session between access point 108 and tag 100. The communication session can take place over wireless communication link 101. FIG. 3 provides an overview of the communication protocol, which is further described below with reference to FIGS. 4-6.

The communication session starts with access point 108 sending out a beacon signal (step 150) encoded with a pseudonoise code (PN code) and modulated with any suitable digital modulation technique. In one embodiment, the beacon signal is encoded with an N=7 PN code (length 2^{N}−1=127) that is modulated with on-off-keying (OOK) of 20 ns wide pulses of the 2.44 GHz carrier at a 9 Mb/s bit (or chip) rate. As used herein, a bit or chip is a single bit of a PN sequence. The beacon signal can be continuously transmitted, intermittently transmitted at predetermined times, or transmitted when the channel is not being used by other devices. If multiple access points 108 are present in the system, the multiple access points 108 can coordinate their beacon transmissions so that the 9 MHz bit rates are synchronized and phase locked between them.

The purpose of the beacon signal is to provide tag 100 with an accurate frequency reference. Typically, tag 100 will not include an accurate frequency reference, such as a crystal or resonator. Tag 100 uses the beacon signal to derive an accurate frequency reference. This technique is advantageous since it does not require an expensive accurate frequency reference to be integrated into tag 100.

Tag 100 has a sleep timer function, which allows tag 100 to enter a very low power sleep state with only the sleep timer running. When the sleep timer expires (step 151), tag 100 powers up (step 152) and starts trying to acquire the beacon signal using a local search algorithm (step 153). The sleep timer function is can be programmed by access points 108 or other devices present in the communications system. The sleep timer may also react to tamper or sensor indications, or a change in the beacon PN code.

Tag 100 searches for the PN code of the beacon signal in a wide enough search space to cover the variation in frequencies due to manufacturing differences and operational drift. PN codes are a family of codes that are easily generated using linear feedback shift registers (LFSRs). As is well known, PN codes have an autocorrelation function that is very low on all but the zero phase point, which makes them suitable as spread spectrum channel discriminators. However, a drawback to the use of PN codes is that correlation/detection at a receiver can require a large number of operations. Specifically, the correlation/detection process can require up to (2^{N}−1)² operations, where 2N−1 is the length of the PN sequence.

To expedite the search process and reduce the number of operations required to detect the beacon signal, tag 100 uses a Fast Walsh Transform (FWT) to efficiently implement a bank of PN correlators. The Walsh transform is a binary transform, most often of length 2^{N}. Walsh transforms have a unique property wherein the columns of the transform matrix can be permuted (reordered) so that the rows of the new matrix consist of all rotations of a given PN code. The permutation can be applied to the input data instead of the matrix, which allows a fast O(N2^{N}) transform to replace the 0(2^{2N}) code search problem. An unpermute function is also needed to reverse the output data after the FWT is complete. By using the FWT to perform a parallelized PN code phase search, the number of operations required to detect the beacon signal is reduced dramatically. For example, if the PN code has a length of 127 bits, a standard search could take on the order of 16,129 operations (127²) whereas a search using the FWT would take 889 operations (7×127).

The Fast Walsh Transform has been described in several publications including the following: a paper entitled “Fast PN Sequence Correlation by using FWT” by Srdjan Z. Budisin in the Mediterranean Electrotechnical Conference Proceedings, 1989; p. 513-515, which describes a known method for using a fast Walsh transform for fast correlation with PN codes; a paper entitled “Hardware Implementation for Fast Convolution with a PN Code Using Field Programmable Gate Array” by Abdulqadir Alaqeeli and Janusz Starzyk, Proc. Southeastern Symposium on System Theory, Athens, Ohio, 2001, which describes using the fast Walsh transform for fast rapid acquisition of PN code phase; and a paper entitled “On Fast M-Sequence Transforms” by Martin Cohn and Abraham Lempel in the IEEE Transactions on Information Theory, January 1977, p. 135-137, which describes using the fast Walsh transform for correlation with a pseudo noise code. These references disclose using the fast Walsh transform correlation/detection of a pseudo noise code. They do not, however, disclose or suggest using a fast Walsh transform to establish an accurate frequency reference signal in a remote device as taught by the present disclosure.

During the acquisition process, tag 100 steps through a sequence of pulse center frequencies (e.g., centered at 2.44 GHz), pulse repetition periods (PRPs) (e.g., centered around 111 ns) and pulse phases as discussed in more detail below. The particular frequencies and periods can vary depending on the application. The search typically starts at the frequency and period of the previous communication session and scans over a limited number of frequency/period/phase combinations wide enough to account for oscillator and voltage controlled oscillator (VCO) drift caused by voltage, temperature, loading and/or other effects that create drift. The FWT beacon capture procedure is covered in more detail below. When the beacon has been acquired, a best match frequency and PRP is provided.

A phase locked loop (PLL) locks onto the beacon signal (step 154) using a bank of early/late PN correlators as a phase detector. The correlators are initialized using the code phase data from the FWT above. The PLL is allowed sufficient time to settle so that it tracks the beacon pulse rate accurately. The beacon signal may also contain one or more additional superimposed synchronization codes with longer or shorter PN code lengths to facilitate faster searches (shorter codes) or more noise rejection (longer codes). The PLL loop bandwidth can be suitably modified dynamically to maximize pull-in range and minimize total search and lock time as is known in the art.

Tag 100 may also search for multiple beacon codes (step not shown). Multiple beacon codes can be transmitted simultaneously by a subset of one or more access points 108 in order to broadcast a low data rate message to multiple tags 100 in the vicinity of the subset of access points 108. The message can be derived, for example, by comparing the FWT peaks of the different beacon codes. This broadcast mechanism can encode a number of data types, including but not limited to a transmit power indication, a sleep/wakeup command and/or a shared element of an encryption scheme such as keys or synchronization information.

Once the PLL is locked onto the 9 MHz beacon bit rate (step 154), the tag transmits an N=16 (length 2^{N}−1=65535) training or pilot PN code using binary phase shift keying (BPSK) modulation of short (2 ns width) pulses centered at 4.1 GHz (step 155). The choice of code length, transmit frequency and modulation scheme is application dependent and the present teachings are not limited in this regard. The access point 108 is constantly or frequently performing a FWT PN code search (step 156) to find training code peaks. The training sequence allows access point 108 to detect the tag signal and allows access point 108 to program a set of multipath or RAKE filter taps to optimize communications with tag 100. This process is described in more detail below.

Tag 100 then proceeds to transmit its unique ID code using two N=14 (length 2^{N}−1=16383) PN codes to represent data bits (step 157). Those of ordinary skill in the art will recognize that other spread spectrum coding techniques can also be used, such as Code Shift Keying or Complementary Code Keying. Access point 108 has a bank of correlators that recover the transmitted data stream (step 158). When the ID code is complete or complete enough to uniquely identify tag 100, one or more access points 108 transmit a coded message and CRC using an N=14 (length 2^{N}−1=16383) PN code pair to encode data bits (step 159). The choice of code type (PN or other) and code length is application dependent.

Access point-to-tag messages are targeted for a particular tag by using a code pair and code phase transmitted on the 2.44 GHz access point-to-tag communication link that is related to or the same as the codes and code phase used in the 4.1 GHz tag-to-access point communication link or indexed to the tag ID. The access point-to-tag message can include a request for supplemental tag data (not shown). Supplemental tag data examples include, but are not limited to, transmit power levels, sleep times, new ID codes or EPCs, security keys, training sequence to data code phase relationship, CRC checksums, etc.

The tag 100 receives the data payload 160 and returns an acknowledge (ACK) 161 which is received by the access point 108 and checked (step 163). Once the tag 100 has processed the received message, the sleep timer is set (step 164) and the tag can power down (step 165).

Access point 108, after accumulating a highly accurate multipath model during data reception, can determine the leading edge timing of the incoming signal to high precision. In addition or in the alternative, the original FWT training code multipath model information can also be used to determine or further constrain the leading edge time of arrival. Once the time of arrival is determined relative to a global reference clock or known reference signals, access point 108 can send the data to server 105 for further processing.

The communication session depicted in FIG. 3 is only one of many possible combinations of communication flows. Those of ordinary skill in the art will recognize that there are many alternative communication flows that are within the scope of the present teachings. For example, tag 100 may request an additional data payload as part of its data message, extending the communication session. Any number of handshaking protocols, security protocols, authentication protocols and/or code sequences can be added, overlaid or substituted and are also within the scope of the present teachings.

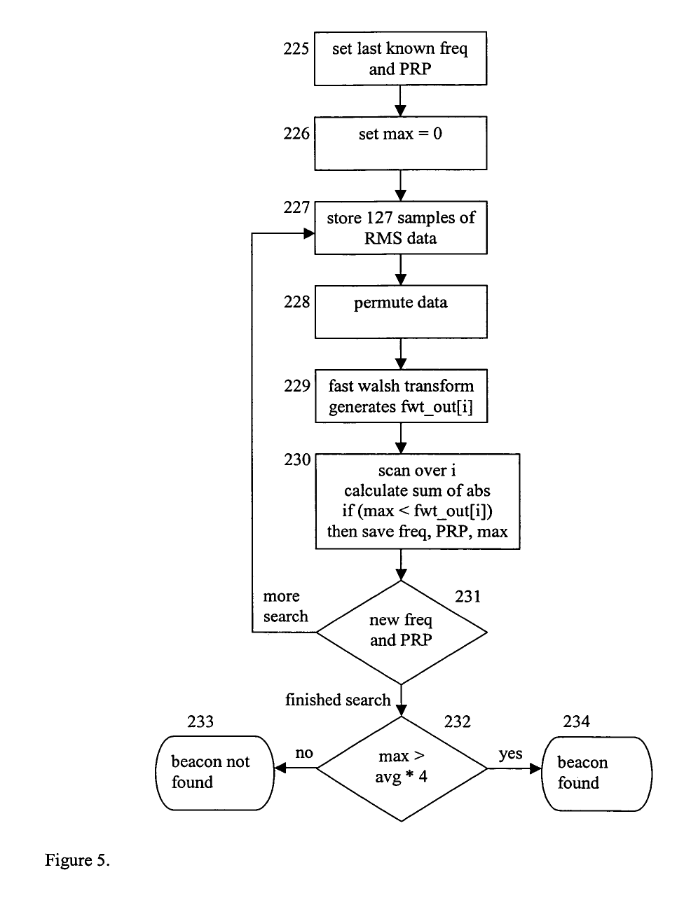

FIG. 4 is an exemplary state flow diagram for tag 100. Tag 100 starts in a sleep state (step 200), and awakes at a given time. An alternative state which checks the state of a particular sensor (e.g. a tamper detector) and returns to sleep if the status is unchanged is not shown, but is within the scope of the present teachings. When the sleep timer expires, tag 100 wakes up and starts searching for a beacon signal (step 201) using a FWT search. This FWT search is further described below with reference to FIG. 5. If the beacon is not found, tag 100 goes into a power/sleep adjustment process (step 210) before returning to sleep (step 200). In one embodiment, if tag 100 fails to find a beacon repeatedly, tag 100 assumes that it is out of range of a beacon and modifies (e.g. extends) its sleep time automatically to preserve battery power.

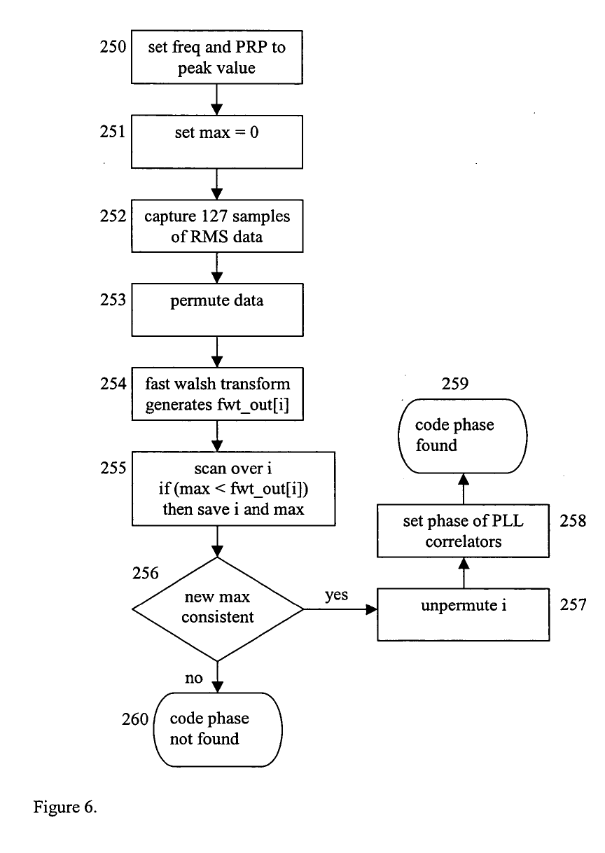

If the beacon is found, tag 100 does a FWT to determine the code phase (step 202). The code phase determination step is further described below with reference to FIG. 6. If the code phase is not found, tag 100 goes into the power/sleep adjust state (step 210) before returning to sleep. In one embodiment, if tag 100 cannot find a valid code phase, tag 100 can extends its sleep time to preserve battery power.

If a valid code phase is found, tag 100 uses a PLL to track the beacon bit rate (step 203). In one embodiment, a PLL having a center frequency of 9 MHz is used. The PLL is given a predetermined time to achieve lock. If it fails to lock, tag 100 enters the power/sleep adjust state (step 210). If the PLL locks, then the tag's PLL is synchronized with the beacon bit rate and it can start transmitting its training sequence using any suitable digital modulation technique (step 204). In one embodiment, an N=16 (length 2^{N}−1=65535) training PN sequence and BPSK modulation is used. Once the training sequence (which might comprise multiple repetitions of the training code) is complete, tag 100 starts transmitting and receiving data using a set of PN codes (step 205). In one embodiment, N=14 (length 2^{N}−1=16383) PN codes are used. Those of ordinary skill in the art will recognize that other spread spectrum coding techniques can also be used, such as Code Shift Keying or Complementary Code Keying.

When the transmission is complete, tag 100 checks the validity of the received data (step 206). If the data message is invalid or corrupt, tag 100 enters power/sleep adjust state (step 210) before going back to sleep (step 200). If the received message is valid, tag 100 proceeds to update variables, first unsecured values (step 207) and then secure variables (step 209) after checking the security key (step 208). For example, when tag 100 wakes up, its reference clock may have drifted significantly from the global clock (determined from the beacon signal). To correct for this drift, a new sleep time variable can be updated in tag 100. This will help ensure that tag 100 will wake up in the next session when access point 108 expects tag 100 to wake up.

FIG. 5 is an exemplary state flow diagram for performing the beacon search (step 201 of FIG. 4). Tag 100 sets the frequency and pulse repetition period (PRP) to the last known good frequency and PRP (step 225). A local variable referred to as “max” is then cleared (step 226). Tag 100 continuously captures samples at the PRP using an analog-to-digital converter (ADC). The sampled data is stored and processed in long sections comprising, for example, 127 samples (step 227). The long sections are permuted (reordered) using a permutation function derived from the LFSR generating polynomial (step 228). A FWT is then performed on the reordered data (step 229). The peak and average absolute value of the FWT output is computed (step 230), where the peak value (max) is retained along with the frequency and PRP of the peak trial. The search continues over a set of local frequencies and PRPs that is wide enough to cover the expected drift between beacon search cycles (step 231). In one embodiment, the search ranges over one or more of the oscillator frequency (e.g., centered at 2.44 GHz), the PRP (e.g., centered at 111 ns) and the phase of the PRP (e.g., 0 to 111 ns). The center values and step size of the search are application dependent and the present teachings are not limited in this regard.

Once the search is finished, tag 100 compares the max value (i.e., the peak of all of the FWT results) to the average absolute value of the FWT results (step 232). If the peak value is sufficiently larger than the average absolute value, tag 100 can with statistical confidence indicate that it has found a beacon (step 234). Otherwise, the beacon is declared not found (step 233). In one embodiment, the max to average-of-absolutes ratio for determining whether a beacon is found is set to 4. Other thresholds or more complex statistical tests (e.g., peak-to-RMS) may be utilized to determine beacon status and are considered within the scope of the present teachings.

FIG. 6 is an exemplary state flow diagram for performing the code phase determination function (step 202 of FIG. 4). The frequency and PRP determined in step 201 (FIG. 6) are first set (step 250). Next, a local variable for peak detection referred to as “max” is cleared (step 251). Tag 100 then captures a new set of 127 samples from its ADC (step 252).

The data is permuted in accordance with the particular PN generating polynomial (step 253). A FWT is then performed on the data (step 254). The output of the FWT is scanned and the peak is found (step 255). The index (i) and the max value are both stored (step 255). The new max value is compared (step 256) to the peak value determined in the beacon search (step 201 of FIG. 4). If they are consistent, the index is fed through the corresponding unpermute function, similarly derived from the PN code generating polynomial to derive the code phase of the beacon code relative to the tag 100 FWT (step 257). The code phase information is then used to set the initial state of a bank of PN correlators (step 258), which are used as a phase detector for the tag pulse rate PLL. If the new max value is consistent with the beacon search peak from step 201 (FIG. 4), the code phase search function exits indicating that it found a code phase (step 259). If the new max value and beacon search peak from 201 are inconsistent (e.g. different by more than 20%) then the code phase search function exits with the code phase not found (step 260). Although not shown in FIG. 6, this process (starting from step 252) may be repeated multiple times before determining that the code phase was not found and exiting (step 260). In a further embodiment, the PRP is varied slightly during each repeat of step 252 to improve the probability of beacon re-detection.

The use of the permute-FWT-unpermute function to perform an efficient broad search for PN codes in noisy data has a number of important benefits, including reduced hardware complexity, improved signal-to-noise ratio (via coding gain), reduced beacon acquisition time, reduced power dissipation, the elimination of expensive frequency references and a simplified tag architecture. A set of slow tracking correlators can be used once the signal frequency, PRP and code phase are known, allowing the FWT engine to be powered down after the beacon acquisition process, thereby saving power. The handoff of code phase between FWT and tracking correlators occurs fast enough to ensure that the beacon is not lost. In one embodiment, the PRP step size is made fine enough to ensure that the code phase handoff and PLL locking is guaranteed. In another embodiment, the PLL loop filter response is modulated to allow rapid lock of the PRP and later slowed down to improve jitter performance.

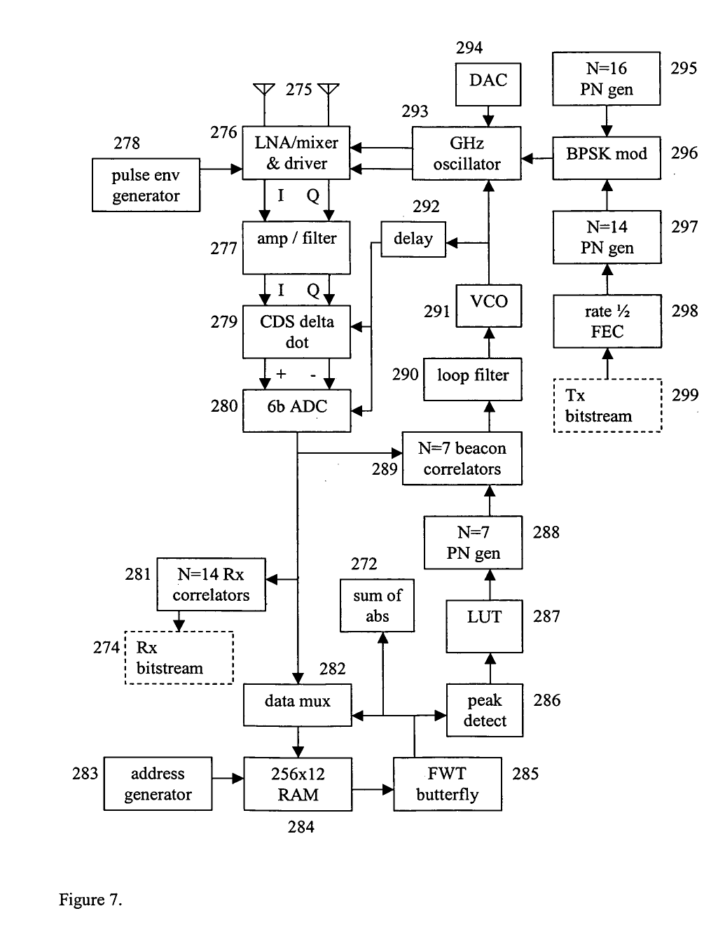

FIG. 7 is a detailed block diagram of an exemplary tag 100. Antennas 275 are attached to a combined low noise amplifier (LNA)/mixer/driver circuit 276 which is connected to an oscillator 293 that can be tuned over a relatively broad range of frequencies, including 4.1 GHz and 2.44 GHz in one embodiment. During data transmission, oscillator 293 provides a differential signal. During data reception, oscillator 293 provides differential quadrature signals through the use of a set of configuration transistors (not shown). LNA/mixer/driver circuit 276 is also driven by a pulse envelope generator 278 that is used to generate the envelope of the transmitted pulse. In one embodiment, the transmitted pulse is around 2 ns wide with a carrier frequency of 4.1 GHz. Pulse envelop generator 278 is controlled by tag 100, which can modulate the timing, power and shape of the pulse. The output waveform preferentially complies with UWB regulations as determined by the FCC.

LNA/mixer/driver circuit 276 in reception mode generates quadrature demodulated signals (I and Q) which are fed into a set of low frequency amplifiers and filters 277. An automatic gain control (AGC) loop (not shown) adjusts the gain of the amplifier 277 according to the received power level. The resultant quadrature signals are sampled by a correlated double sampling (CDS) circuit 279 that computes the differences of the dot products of 3 sets of CDS IQ samples to create a single differential analog output. Alternatively, CDS circuit 279 calculates the changes between two sequential samples of I and Q (e.g., I₁-I₀ and Q₁-Q₀). In one embodiment, the output of the CDS delta-dot circuit 279 is digitized at the beacon bit rate (e.g., 9 MHz) with one or more offset compensated analog-to-digital converter(s) (ADC) 280 having a 6-bit resolution. The output of ADC 280 is fed into a data multiplexer 282, a set of N=7 beacon correlators 289 and a set of N=14 receiver correlators 281. Data multiplexer 282 is connected to a random access memory (RAM) 284, which is used for the FWT operation, among other things. In one embodiment, RAM 284 is 256 words by 12 bits. An address generator 283 is connected to RAM 284 and controls the address bus of RAM 284. Address generator 283 implements the sequencing required by the permute and FWT functions. RAM 284 is also connected to a FWT butterfly 285, which computes a FWT primitive function. The output of the FWT butterfly 285 is fed back into data multiplexer 282, into a peak detector 286, and into a sum-of-absolutes accumulator 272. Peak detector 286 is used to determine the maximum value of the FWT output results for use in the beacon search and the code phase search. The output of peak detector 286 is provided to a lookup table 287 that takes the peak index from the FWT sequence and translates it into an initial state for the beacon tracking PN generator 288. Look up table (LUT) 287 combines the FWT output sequence (which is out of order), the unpermute function, and the code phase-to-LFSR state mapping to initialize the 7-bit LFSR in the PN generator 288 (N=7) to be synchronous with the beacon code.

The synchronized PN code from PN generator 288 drives a bank of correlators 289 that are used as a phase detector for the PRP PLL. These beacon correlators 289 provide an early-late signal, which can be used to decrease or increase the local PLL frequency to track the beacon bit frequency. The early-late signal is fed into a digital loop filter 290 which low-pass filters the signal. The response characteristic of loop filter 290 is modulated to first optimize acquisition time when the PLL first starts tracking and then optimizes jitter once the PLL achieves lock. The loop filter output drives a voltage controlled oscillator (VCO) 291, which generates the sample frequency of CDS delta dot circuit 279 and ADC 280 (e.g., 9 MHz=the beacon bit rate). Early/late samples can be also generated by dithering the delay 292 of the sampling clock to give a fine (sub chip) early/late signal. ADC 280, CDS delta-dot 279, beacon correlators 289, loop filter 290, VCO 291 and delay 292 form a closed loop PLL that locks onto the beacon bit rate, which is centered at 9 MHz in one embodiment.

During the beacon search operation, the PLL loop is open. VCO 291 is driven from memory with digital values at or near those from the last communication session. The frequency of oscillator 293 is similarly controlled by another digital-to-analog converter (DAC) 294, which in one embodiment sets oscillator 293 at nominally 4.1 GHz for transmission and 2.44 GHz for receive. Alternatively, the frequency of oscillator 293 can be a multiple of the VCO 291 frequency (e.g., 2,439 MHz, which is 271 times the 9 MHz beacon rate).

In another embodiment, tag 100 can contain calibration memory that is tuned during a special testing step. The oscillator frequency, for example, may be stable enough so that it does not need to be actively searched as part of the beacon search process. Alternatively, the frequency can be intermittently searched. The extent, granularity and combinations of beacon searches are not restricted by the present teachings.

For transmitting data, the transmitted bitstream 299 is fed into an optional forward error correction (FEC) encoder 298. In one embodiment, FEC encoder 298 is a rate ½ convolutional coder with K=7. The encoded data stream selects one of two N=14 (length 2^{N}−1=16383) codes for transmission from a PN generator 297. The expanded bit stream is sent to a BPSK modulator 296, which provides startup kicks to the oscillator 293. Additionally, an N=16 (length 2^{N}−1=65535) PN generator 295 drives the BPSK modulator 296 during the training phase.

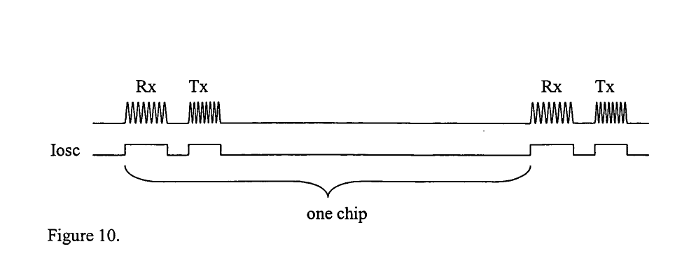

Oscillator 293 can be designed so that it is powered down during each bit period to save power. In one embodiment, oscillator 293 is a pulsed oscillator, requiring a startup kick to have deterministic phase relative to the 9 MHz beacon frequency. The kickoff pulses are generated by the BPSK modulator 296 according to the desired bit state during transmission. Access points 108 implement coherent detection, which requires precise phase alignment of the transmitted pulses relative to the beacon bit frequency, provided by the beacon tracking PLL within the tag. Oscillator 293 can thus be powered down during a significant portion of each 111 ns bit (or chip) period after the Rx samples have been received and Tx pulses have been sent. FIG. 10 is a timing diagram that illustrates how the oscillator only needs to produce a signal (I_{OSC}) for a relatively short portion of the chip period. By shutting down the oscillator during each chip period, significant power savings can be achieved. The synchronization and phase-noise requirements for coherent communications from the tag to the access point are shifted from high-frequency oscillator 293 to the low frequency (e.g., 9 MHz) PLL loop.

In another embodiment, the beacon tracking function is not coherent and does not require precise phase alignment. During data reception, oscillator 293 drives the mixer 276 for a short period of time (e.g. 20 ns out of the 111 ns chip period) to sample the OOK beacon pulsed signal. During data transmission, oscillator 293 also drives mixer 276 for a short period of time (e.g., 5 ns of the 111 ns chip period). The short oscillation periods conserve power. In another embodiment, oscillator 293 is comprised of a quadrature ring oscillator with a programmed starting phase and time. In yet another embodiment, two separate oscillators 293 are used to generate transmit and receive local oscillator signals. Each oscillator can then be suitably optimized for 2.44 GHz (Rx) and 4.1 GHz (Tx) frequencies independently. The power savings from the power cycling during the bit period can be similarly achieved by duty cycling each of the Tx and Rx oscillators so that they are only active for a short duration during each bit period. The power cycle per bit period feature and multimode circuit allow rapid full duplex communications without large episodic transitions of the tag Rx/Tx circuitry as is common in many radios today. The low latency full duplex communications lessens the need for complex data storage and media access circuitry in the tag. In addition to the embodiments described herein, those of ordinary skill in the art will recognize that oscillator 293 can be implemented in numerous other ways, all of which are within the scope of the present teachings.

In addition to oscillator 293, other circuitry within tag 100 can be powered down during the bit period to save power. For example, the LNA, mixer and driver circuit 276 can be powered down when not in receive mode during the bit period (e.g. 91 ns out of 111 ns powered down) to conserve battery power. The receive mode can precede the transmit mode in the bit period so that any reflections or residual effects of the transmit pulse generation will be maximally attenuated before tag 100 reenters receive mode.

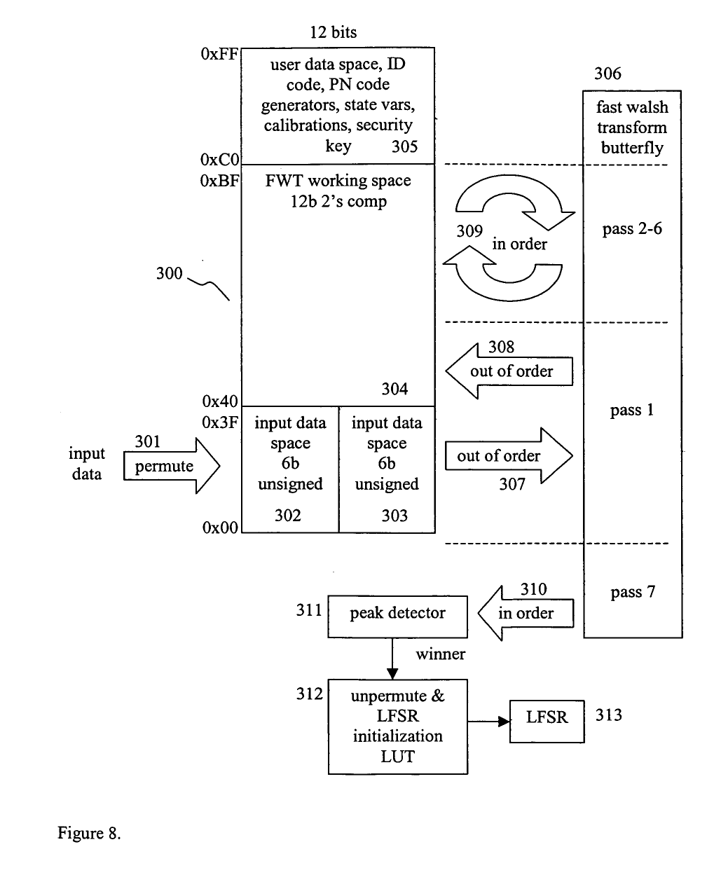

FIG. 8 shows an exemplary operation diagram for the FWT performed in tag 100 of FIG. 7. The 256×12 RAM 284 is divided into 3 segments. Locations 0x00 through 0x3F are reserved for packed input data 302, 303 from CDS delta dot or RMS calculator 279. Locations 0x40 through 0xBF are reserved for the FWT intermediate results 304. Locations 0xC0 through 0xFF are used for user data such as ID codes, security keys, state variables, PN code generator functions, calibration values, power levels and/or electronic product codes (EPC) 305.

The incoming RMS data is stored in permuted order 301 and packed two samples per word. The FWT engine, on the first of 7 passes reads the data out of the RAM 284 out of order 307 to prevent new incoming data from overwriting old data. The FWT butterfly 285 results are similarly out of order and are written as such 308 back into the FWT area of the RAM 304. FWT passes 2 through 6 (309) are in standard FWT order. The final pass of the FWT is also done in order 310 but the results are not written back into the RAM 284. The results of the final pass are fed into a peak detector 286, which declares a winner index. The winning index is subsequently fed into a LUT 287, which translates the 7-bit index into a 7b initialization value for the PN generator 288. The bit widths, locations and computation order, among other things, can be modified depending on the application and are within the scope of the present teachings.

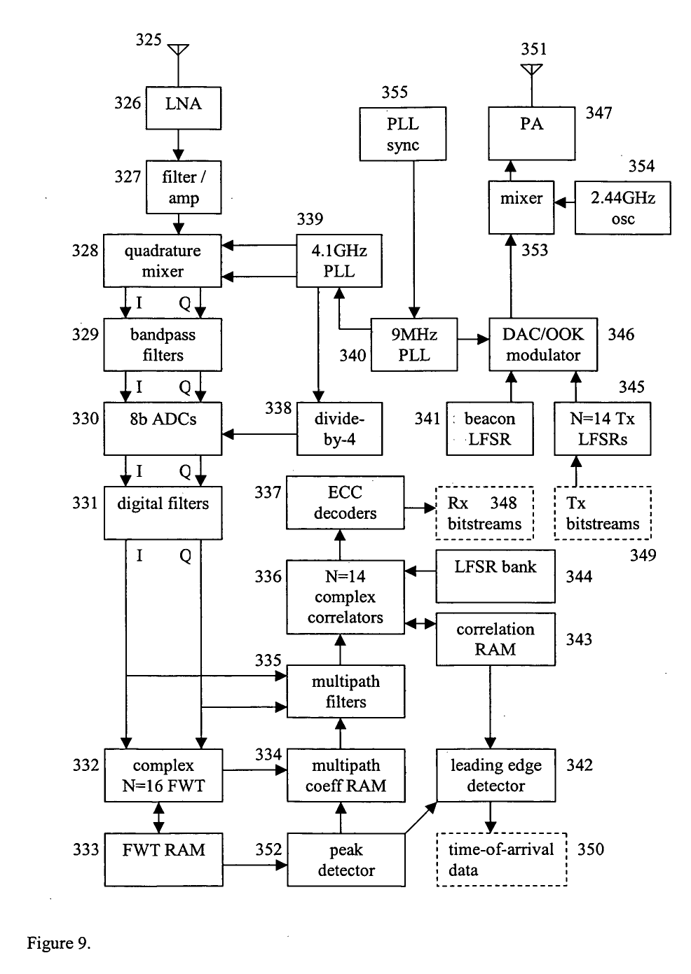

FIG. 9 is a block diagram of an exemplary access point 108. A receiving antenna 325 is connected to a low noise amplifier (LNA) 326, which drives a filter 327, which restricts the bandwidth of the incoming signal. The signal is fed into a quadrature mixer 328 which generates downconverted quadrature component signals (I and Q). Quadrature mixer 328 is also driven by a PLL 339 at 4.1 GHz nominally. The quadrature signals from mixer 328 are subsequently passed through two bandpass filters 329 and digitized by two ADCs 330. The resultant digital quadrature signals are further filtered in the digital domain by 331.

The filtered quadrature signals are fed into an N=16 complex FWT engine 332 which searches the received waveform for training sequences transmitted by tags 100. A FWT RAM 333 for storing intermediate results is attached to the FWT engine 332. A peak detector 352 is used to determine the existence and code phase of a training signal from a tag 100 in the received signal.

The outputs of FWT engine 334 and peak detector 352 are fed into a multipath coefficient RAM 334. In one embodiment, the multipath coefficient RAM 334 data is used to program a bank of multipath filters 335 which implement a RAKE combiner for improving the signal-to-noise ratio and immunity to multipath corruption. To program a RAKE combiner with M taps, first the M largest (sorted by magnitude, real, imaginary or any combination) complex I and Q FWT points within a predefined time window around the global peak of all the FWT results are extracted from the multipath coefficient RAM 334. These M largest correlation peaks represent the M largest reflections of the incident signal. The time window for the magnitude sort is determined by the amount of reflection lag that can be reasonably expected in a given installation. In a representative example, the magnitude sort window is −100 ns to +500 ns relative to the global peak position. Such a window allows for some early arrival and a large amount of late arrival from reflections with path length differences up to 500 feet. In one embodiment, the multipath filters 335 are programmed with the complex conjugate of the largest magnitude Walsh function results within the preset window time around the global FWT peak.

The output of multipath filters 335 is sent to a bank of N=14 complex correlators 336 which extract the data bits from the received streams as encoded by tags 100. The output of complex correlators 336 is optionally fed into a bank of error correcting code (ECC) decoders 337, which recovers the original tag data bitstream as the Rx bitstream 348. A bank of LFSRs 344 (PN code generators) provides the sequences for complex correlators 336. Complex correlators 336 can also optionally correlate the data stream from digital filter 331 directly to accumulate a highly accurate multipath model over the length of the data transmission. The results are stored in a correlation RAM 343. The contents of correlation RAM 343 and peak detector 352 are used to determine the leading edge of the pulse stream using a leading edge detector 342 which computes the times of arrival 350 for the data streams relative to a calibrated timer (not shown) that is synchronized between multiple access points and/or to multiple reference tag signals at known positions.

The transmit side of access point 108 is driven by a beacon code generator 341 LFSR which creates the coded beacon sequence. The transmitted messages, acknowledge (ACK) messages, and any supplemental data is combined into a Tx data stream 349 which drives a set of N=14 Tx PN code generators (also referred to as “LFSRs”) 345. The beacon LFSR 341 and Tx LFSR 345 both drive a DAC/OOK modulator 346, which superimposes the beacon and data signals to create a combined single output waveform. The output signal drives mixer 353 and then a power amplifier 347 which drives transmit antenna 351. A 2.44 GHz local oscillator 354 also drives the mixer 353.

A 9 MHz PLL 340 is locked to other access points via a synchronization circuit 355. The 4.1 GHz PLL 339 is locked to the 9 MHz PLL 340. A divide-by-4 circuit 338 provides a 1.025 GHz sampling clock to ADCs 330. The 9 MHz PLL 340 drives beacon modulator 346.

Those of skill in the art will recognize that the various embodiments disclosed herein are susceptible to various modifications and alternative forms, and specific examples thereof have been shown by way of example in the drawings and are herein described in detail.

1. A wireless communication system comprising:
at least one tag having a spread spectrum receiver; and
at least one access point having a spread spectrum transmitter;
wherein the access point is capable of transmitting a first signal encoded with a predetermined binary sequence, and the tag is capable of receiving the first signal and performing a fast Walsh transform using the predetermined binary sequence to establish an accurate frequency reference signal within the tag, the accurate frequency reference signal allowing the tag and access point to transfer information to one another via a wireless, spread spectrum communication link.

2. The system of claim 1 wherein the predetermined binary sequence is a pseudonoise (PN) sequence.

3. The system of claim 1 wherein the tag does not include a crystal oscillator.

4. The system of claim 1 wherein the tag is capable of permuting the predetermined binary sequence before performing the fast Walsh transform.

5. The system of claim 1 further comprising a server capable of transferring information to the access points.

6. The system of claim 1 further comprising a server capable of transferring information to the tag.

7. The system of claim 1 wherein the tag begins searching for the first signal after it exits a sleep mode.

8. The system of claim 1 wherein the tag further comprises a phase lock loop (PLL) that locks onto the frequency of the first signal.

9. The system of claim 1 wherein the tag transmits a second signal encoded with a predetermined binary sequence and the access point performs a fast Walsh transform using the predetermined binary sequence of the second signal.

10. The system of claim 1 wherein the system includes multiple tags and multiple access points.

11. The system of claim 1 wherein the tag and access point are located in a retail store and the tag is used to display pricing information to customers.

12. A method performed in a wireless communication system, the method comprising:
transmitting the beacon signal over a wireless communications link;
receiving the beacon signal from the wireless communications link;
searching for the beacon signal by performing a fast Walsh transform using the digital data; and
establishing an accurate frequency reference signal based on digital data included within the beacon signal if the results of the fast Walsh transform indicate that the beacon signal has been located.

13. The method of claim 12 wherein the accurate frequency reference signal allows information to be transferred between a tag and an access point via a wireless, spread spectrum communication link.

14. The method of claim 12 wherein the beacon signal includes a pseudonoise (PN) sequence.

15. The method of claim 12 further comprising permuting the digital data before performing the fast Walsh transform.

16. The method of claim 12 further comprising locking onto the frequency of the beacon signal using a phase locked loop (PLL) after the beacon signal has been located.

17. The method of claim 12 further comprising:
transmitting a training signal encoded with a predetermined binary sequence;
receiving the training signal; and
performing a fast Walsh transform using the training signal.

18. A wireless communication device comprising:
an antenna;
a spread spectrum receiver in electrical communication with the antenna; and
a processor in electrical communication with the receiver;
wherein an accurate frequency reference signal is established in the wireless communication device by receiving a first signal encoded with a predetermined binary sequence and performing a fast Walsh transform using the predetermined binary sequence of the first signal.

19. The wireless communication device of claim 18 wherein the predetermined binary sequence is a pseudonoise (PN) sequence.

20. The wireless communication device of claim 18 wherein the wireless communication device does not include a crystal oscillator.

21. The wireless communication device of claim 18 wherein the wireless communication device permutes the predetermined binary sequence before performing the fast Walsh transform.

22. The wireless communication device of claim 18 wherein the wireless communication device begins searching for the first signal after it exits a sleep mode.

23. The wireless communication device of claim 18 wherein the wireless communication device further comprises a phase lock loop (PLL) that locks onto the frequency first signal.

24. The wireless communication device of claim 18 wherein the wireless communications device transmits a second signal encoded with a predetermined binary sequence.

25. The wireless communication device of claim 18 wherein the wireless communication device is located in a retail store and used to display pricing information to customers.

26. The wireless communication device of claim 18 further comprising a display for displaying information in a retail store, wherein the displayed information can be updated when the wireless communications device receives updated display information.

27. The wireless communication device of claim 18 wherein the wireless communication device is capable of receiving initialization information from an initialization device.

28. A method performed in a wireless communication device, the method comprising:
receiving a beacon signal from a wireless communications link;
searching for the beacon signal by performing a fast Walsh transform using digital data included in the beacon signal; and
establishing an accurate frequency reference signal if the results of the fast Walsh transform indicate that the beacon signal has been located.

29. The method of claim 28 wherein the accurate frequency reference signal enables the transfer of information between the wireless communication device and another wireless communication device via a wireless, spread spectrum communication link.

30. The method of claim 28 wherein the digital data includes a pseudonoise (PN) sequence.

31. The method of claim 28 further comprising permuting the digital data before performing the fast Walsh transform.

32. The method of claim 28 further comprising locking onto the frequency of the beacon signal using a phase locked loop (PLL) after the beacon signal has been located.

33. The method of claim 28 further comprising transmitting a signal having a training sequence.

34. The method of claim 28 further comprising displaying pricing information.

35. The method of claim 28 further comprising:
displaying pricing information; and
updating pricing information when the wireless communications device receives updated pricing information.

36. The method of claim 28 further comprising receiving initialization information from an initialization device.

37. A wireless communication device comprising:
an antenna;
a spread spectrum transceiver in electrical communication with the antenna; and
a processor in electrical communication with the transceiver;
wherein the wireless communication device is capable of transmitting a first signal encoded with a predetermined binary sequence, the first signal enabling a plurality of tags to establish an accurate frequency reference signal by performing a fast Walsh transform on the predetermined binary sequence.

38. The wireless communication device of claim 37 wherein the predetermined binary sequence is a pseudonoise (PN) sequence.

39. The wireless communication device of claim 37 wherein the wireless communication device includes a crystal oscillator.

40. The wireless communication device of claim 37 wherein the wireless communications device receives a second signal encoded with a predetermined binary sequence and the wireless communications device performs a fast Walsh transform using the predetermined binary sequence.

41. The wireless communication device of claim 37 wherein the wireless communication device is capable of transmitting pricing information.

42. A method performed in a wireless communication device, the method comprising:
transmitting a first signal encoded with a first predetermined binary sequence;
receiving a second signal encoded with a second predetermined binary sequence;
generating digital data using the second signal; and
performing a fast Walsh transform on the digital data.

43. The method of claim 42 wherein the first predetermined binary sequence is a pseudonoise (PN) sequence.

44. The method of claim 42 wherein the second predetermined binary sequence is a pseudonoise (PN) sequence.

45. The method of claim 42 further comprising permuting the digital data before performing the fast Walsh transform.

46. The method of claim 42 further comprising transmitting pricing information.

47. The method of claim 42 further comprising transmitting pricing information to a tag, wherein the tag displays the pricing information to customers in a retail store.

48. A method for reducing the amount of power consumed in a wireless communication device, the method comprising:
during a chip period, generating a first signal to be used in receiving for receiving data and ceasing the generation of the first signal when the data has been received; and
during the chip period, generating a second signal to be used in tranmitting data and ceasing generation of the second signal when the data has been transmitted.

49. The method of claim 48 wherein the amount of time that the first and second signals are being generated are less than 75% of the chip period.

50. The method of claim 48 wherein the amount of time that the first and second signals are being generated are less than 50% of the chip period.

51. The method of claim 48 wherein the amount of time that the first and second signals are being generated are less than 25% of the chip period.

52. The method of claim 48 wherein the first and second signals are generated by the same oscillator.

53. The method of claim 48 wherein the first and second signals are generated by first and second oscillators, respectively.

54. A method for maintaining an accurate frequency reference signal in a wireless communication device, the method comprising:
searching for a beacon signal, the beacon signal being encoded with a binary sequency and being used to generate an accurate frequency reference signal within the wireless communication device; and
after locating the beacon signal, tracking the binary sequence such that the accurate frequency reference signal is maintained in the wireless communication device.

55. The method of claim 54 wherein the searching step is performed at least in part using a fast Walsh transform.

56. The method of claim 54 wherein the tracking is performed at least in part by multiple correlators.

57. A method for programing the taps of a RAKE filter used in a wireless communications device:
receiving a signal encoded with a binary sequence;
generating digital data from the signal;
performing a fast Walsh transforms on the digital data; and
using the results of the fast Walsh transforms to program the taps of the RAKE filter.

58. The method of claim 57 wherein the binary sequence is a pseudonoise (PN) sequence.

59. The method of claim 57 further comprising permuting the digital data before performing the fast Walsh transforms.
